(19) United States
(12) Patent Application Publication
(10) Pub. No.: US 2008/0308613 A1
(43) Pub. Date: Dec. 18, 2008

(54) TAMPER EVIDENT TAPES AND PACKAGES

(75) Inventor: Neil FREDER, Hampstead (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: NELMAR SECURITY PACKAGING SYSTEMS INC.(a Canadian company), Terrebonne (CA)

(21) Appl. No.: 12/051,153

(22) Filed: Mar. 19, 2008

Related U.S. Application Data
(60) Provisional application No. 60/907,058, filed on Mar. 19, 2007.

(51) Int. Cl. B65D 27/30; B32B 5/00; B65D 27/14

(52) U.S. Cl. 229/80; 428/192; 229/102

(57) ABSTRACT

The invention relates to tamper evident tapes or soft packages, such as plastic bags or envelop, including new security features for sealing and rendering irreversible and unambiguously visible the opening of the package. The first new security feature concerns a plurality of U-shaped cuts extending through the tape, each U-shaped cut having an open end and a closed end defining a tearing edge. The U-shaped cuts are distributed and oriented along the tape so that the tearing edges thereof extend in multiple directions. The second new security feature is a thermochromatic layer present inside the tape and overlaying heat sensitive tamper-indicating areas also present in the tape. The thermochromatic ink layer intermingles with some markings also present therein and comprises an irreversible thermochromatic ink invisible at room temperature and activated at an activation temperature superior to the room temperature.

### PRIORITY

This application claims the benefit of U.S. Provisional Application No. 60/907,058 filed on Mar. 19, 2007.

### FIELD OF THE INVENTION

The present invention relates to the field of tamper evident tapes and packages. More particularly, but not exclusively, this invention relates to a tamper evident tape for sealing a package comprising security features rendering irreversible and unambiguously visible the opening of the package.

### BACKGROUND OF THE INVENTION

In order to make unambiguously visible the unauthorized opening of packages, such as cartons, pouches, envelopes, bags, boxes or the like, tapes referred to as “tamper evident tapes” or “adhesive security tapes” have been widely used for decades. For example, such security tapes may be used by banks or retailers for moving currencies.

After a package has been sealed, the appearance of security features present in adhesive security tapes may be unremarkable. However, when the tape is breached or peeled off from the package, signs of the tampering become apparent and remain clearly visible even following attempts at resealing. As a result, the intended recipient of the package can see that it has been previously opened and can take proper action based on this knowledge.

Several tamper-evident security features are known in the art. One of the most common such feature consists in a warning word such as “VOID”, “OPENED” or the like remaining on the package upon removal of the tape. This is generally accomplished through the use of a layer of release material, patterned to form the warning message, being disposed between the adhesive layer of the tape and a uniform ink layer under the tape substrate. Upon removing the tape from a package, the portion of the ink layer in contact with the release material remains on the package, forming the warning message, and the absence of ink on the tape substrate will also form the warning message. This technique is not always efficient, however, as thieves may hide the evidence of tampering by carefully reapplying the tape or using a marker of the same color as the ink layer to “fill-in” the missing pattern.

Another issue with the patterning of release material to form a warning message is that the release material may not remain on the package at extreme temperatures. Thieves therefore heat or freeze the tape to remove it from the package without leaving any trace. With respect to heat, one solution known in the art is to apply a layer of thermochromatic ink to the tape. This tape of ink is not apparent at room temperature, but will suddenly become visible when a certain threshold temperature is reached. Some available thermochromatic inks are irreversible, thereby leaving a trace of the tampering after the fact.

Various types of security tape or labels of the like are for example described in U.S. Pat. No. 5,582,434 (SKOV et al.; 1996), U.S. patent application No. U.S. 2003/0056891 A1 (SCHRODER et al.), patent application No. U.S. 2007/0024050 A1 (WHITE et al.), U.S. Pat. No. 6,998,168 B2 (YU), U.S. Pat. No. 6,881,476 B2 (NOEHTE et al.), U.S. Pat. No. 5,862,101 (HANS et al.), or U.S. Pat. No. 5,582,887 (ETHEREDGE).

Other prior art techniques affect the integrity of the tape upon removal, making it difficult to reapply it to hide the tampering. For example, U.S. Pat. No. 5,013,088 (MARIN) discloses a disintegrating tamper-proof masking label. This masking label contains tamper proof multi-directional X-shaped cuts which cause the label to disintegrate upon removal from a masked medium. Security tapes containing X-shaped cuts are however difficult to manufacture due to the possibility of uncontrolled tearing during the manufacturing process. Furthermore, sharp X-shaped cuts may result in an unwanted tape fragility during the customary and normal tape use (closing, sealing, transporting).

A further security feature may be introduced in a security tape by using serrated edges. Serrated-edges reduce the risk of someone attempting to tamper with seal by using a cutting tool (such as a razor blade) to cut along the edges of the tape to gain entry into the bag. This scenario is more likely when a bag is sealed with a “straight edge” tape and even more likely when the adhesive “backing” of the tape in question does not cover the entirety of the tape. U.S. Pat. No. 6,413,605 B1 (HOFFER) or U.S. application No. 2001/0006291 A1 (WENNIGER et al.) disclose tamper-evident tapes which have, amongst other features, serrated edges. The serrations along the edges cause the tape to tear into strips when it is peeled away from those edges. The tape may have also perforations in it at various points that cause it to tear into strips when it is peeled away from those openings.

Hence, in light of the aforementioned, there is still a need for new security tapes and packages, which by virtue of their design and components, would be able to overcome some and preferably all of the aforementioned prior art problems.

### SUMMARY OF THE INVENTION

An object of the present invention is then to provide a tamper evident tape and tamper evident soft package that satisfy the above-mentioned need.

More specifically, an object of the invention is to provide a tamper evident tape and tamper evident soft package including new security features rendering irreversible and unambiguously noticeable the removal of the tape form a closure or the opening of the soft package.

In accordance with a first aspect of the present invention, there is provided a tear-inducing tamper evident tape for sealing a package. The tape has a first elongated substrate layer made of a plastic material and having a top and a bottom surface. The substrate layer has a plurality of U-shaped cuts extending therethrough, each U-shaped cut having an open end and a closed end, the closed end defining a tearing edge. The U-shaped cuts is distributed and oriented along the substrate layer so that the tearing edges thereof extend in multiple directions. The tape also includes an adhesive layer extending along the bottom surface of the substrate layer for adhering the tape to the package.

The invention also provides a tear-inducing tamper evident soft package, having a first and a second wall made of a soft material and joined together to form an enclosure having an opening, and an elongated sealing region extending longitudinally along the opening and having an outside and inside surface. The sealing region includes an elongated substrate layer having a bottom surface facing inwardly of the opening. The substrate layer has a plurality of U-shaped cuts extending therethrough. Each U-shaped cut has an open end and a closed end, the closed end defining a tearing edge, the U-shaped cuts being distributed and oriented along the substrate layer so that the tearing edges thereof extend in multiple directions. The sealing region also includes an adhesive layer extending along the bottom surface of the substrate layer and disposed to contact both the first and second walls for sealing the package.

Advantageously, the presence of U-shaped cuts, also merely named U-cuts herein after, through the substrate layer of the tear-inducing tamper evident tape of the invention, will result in the tape tearing because the tape is being removed from the surface on which it was initially applied to. More precisely, the portion of the tape extending within the “U” of the U-cuts will remain affixed to the surface while the balance of the tape will be peeled off of the surface in question. The combination of some portions of the tape remaining affixed and some portions of the tape being removed from their original surface area provide for the tearing of the tape in question. The more tape surface that is removed from the original surface after encountering a U-cut, the longer and more severe are the tears in the tape.

The multi-directionality of the U-cuts also plays a role in the effectiveness of this particular security feature. In a preferred embodiment, the U-cuts are placed in such a fashion as to “react” no matter what direction the tape is being peeled off from. This means that the U-cuts will become “active” if the tape is being peeled off the surface on which it was applied in a left to right direction, right to left direction, top to bottom direction and bottom to top direction.

Compared to the X-cuts known in the Art, the multi-directional U-cuts have the principal advantage improving the integrity of the tape during the customary/normal tape closing/sealing procedure while keeping a desired fragility level during the tampering attempts. Further, the Applicant has noted a net improvement in the making of the tape in that “U” dye cutting with comparison to “X” die cutting.

In accordance with a second aspect of the present invention, there is also provided a heat sensitive tamper evident tape for sealing a package. The tape includes an elongated substrate layer made of a plastic material having a top and a bottom surface and an adhesive layer extending along the bottom surface of the substrate layer for adhering the tape to the package.

The tape also has a visible ink layer sandwiched between the substrate and adhesive layers and delimiting a plurality of heat sensitive tamper-indicating areas along the substrate layer, the visible ink layer defining markings within each heat sensitive tamper-indicating area.

The tape further includes a thermochromatic ink layer sandwiched between the substrate and adhesive layers, the thermochromatic layer overlaying the heat sensitive tamper-indicating areas and being intermingled with the markings therein, the thermochromatic ink layer including an irreversible thermochromatic ink invisible at room temperature and activated at an activation temperature superior to the room temperature.

There is also provided a heat sensitive tamper evident soft package, including a first and a second wall made of a soft material and joined together to form an enclosure having an opening, and an elongated sealing region extending longitudinally along the opening and having an outside and inside surface. The sealing region has an elongated substrate layer having a bottom surface facing inwardly of the opening, an adhesive layer extending along the bottom surface of the substrate layer and disposed to contact both the first and second walls for sealing the package; a visible ink layer sandwiched between the substrate and adhesive layers and delimiting a plurality of heat sensitive tamper-indicating areas along the substrate layer, the ink layer defining markings within each heat sensitive tamper-indicating area; and a thermochromatic ink layer sandwiched between the substrate and adhesive layers, the thermochromatic layer overlaying the heat sensitive tamper-indicating areas and being intermingled with the markings therein, the thermochromatic layer including an irreversible thermochromatic ink invisible at room temperature and activated at an activation temperature superior to the room temperature.

The combined use of a thermochromatic ink layer overlying a heat sensitive tamper-indicating area in a visible ink layer is advantageous in that heating the tape in the attempt to melt the adhesive and peel-off the tape will result in the formation of a thermochromatic ink spot in the middle of the tamper-indicating area, attracting the attention of any person verifying the integrity of the closure. Also advantageously, the thermochromatic spot is intermingled with markings also present in the tamper-indicating area, so that attempts at “washing-off” the thermochromatic ink will also remove the markings in question.

Security features defined above may also be part of security labels. The present invention is then also directed to secured labels including at least one of the secured features defined above.

The objects, advantages and other features of the present invention will be better understood upon reading of the following non-restrictive description of preferred embodiments thereof, given for the purpose of exemplification only, made with reference to the following drawings (not drawn to scale) and example.

### DESCRIPTION OF THE DRAWINGS

FIG. 1 is a partial top view of a tear-inducing temper evident tape according to a preferred embodiment of the invention.

FIG. 2 is a partial top view of a heat-sensitive temper evident tape according to another preferred embodiment of the invention.

FIG. 3 is a cross-sectional side view taking along line III-III in FIG. 2.

FIG. 4 is a front view of a tear-inducing temper evident soft package according to a preferred embodiment of the invention.

FIG. 5 is a front view of a heat-sensitive temper evident soft package according to another preferred embodiment of the invention.

### DETAILED DESCRIPTION OF PREFERRED EMBODIMENTS

In the present description, the following terminology will be used in accordance with the definitions set out below.

By “tape”, it is understood an elongated strip or band of material having its back covered of an adhesive material, such as the ones commonly used in the tape industry.

By “label”, it is understood a limited piece of tape to place on a package on which are present permanent hand written, printed, stamped, embossed or engraved information, the information being related to the package (nature, owner, destination, etc).

By “plastic material”, it is understood any sort of natural or synthetic polymeric material including polymer, copolymer or the like generally used in the art of tape or label.

By “about”, it is understood that the measures indicated in the present application have a precision which cannot be inferior to the precision of the apparatus used to get this measure. It is commonly accepted that a 10% precision measure is acceptable and encompasses the term “about”.

By “room temperature” or “ambient temperature” it is understood the temperature where the tapes and packages of the present invention have been manufactured, stored and used. By “tampering attempt” it is understood someone trying to gain entry via the tape closure into a sealed package or the like.

### Tear-Inducing Tamper Evident Tape

As aforesaid, in accordance with a first aspect of the present invention there is provided a tear-inducing tamper evident tape for sealing a package such as cartons, pouches, envelopes, plastic bags, boxes or the like.

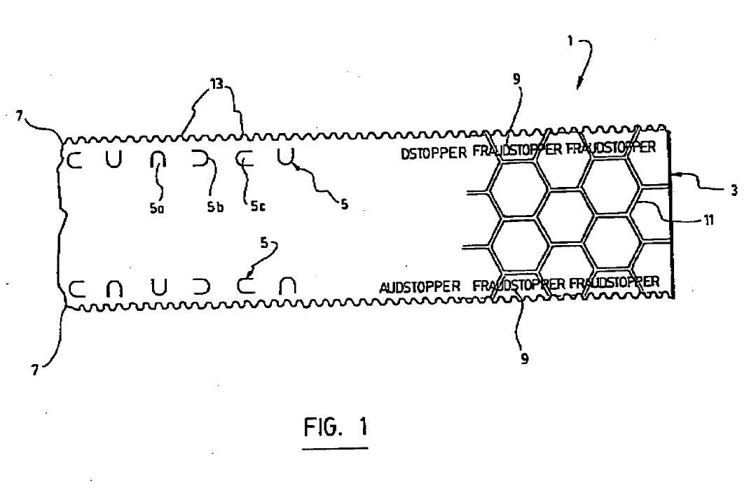

According to a preferred embodiment, as the one illustrated on FIG. 1, the tear-inducing tamper evident tape (1), commonly named “tape” herein after, includes an elongated substrate layer (3) made of a plastic material. Preferably, the plastic material may be selected from polyethylene, polypropylene, polyester, polystyrene and acetate. However, it has to be understood that other kind of plastic material well known in the art of tape may be used.

The width and length of the tape generally equal the width and length of the elongated substrate layer thereof, and are variable depending on considered uses for the tape. For example, the width of the tape illustrated on the enclosed Figures is about 40 mm.

As illustrated on FIG. 1, the substrate layer (3) has a plurality of U-shaped cuts (5) extending through the layer (3) but mostly invisible for a naked eyes.

By “U”, it has to be understood that the cut has the form of a capital letter “U” or can also be referred as a “horseshoe”-shaped cut.

Each U-shaped cut has an open end (5a) and a closed end (5b). The size of the U-shaped cut can be variable and depends on the width and length of the tape.

The closed end (5b) of the cut defines a tearing edge in that that the center of the U-cuts (5c) will remain stick on the package when the tape (1) will be peeled-off longitudinally regarding the U-cuts, causing an irreversible tearing of the tape from the closed end (5b) of the U-cuts.

In order to maximize the destruction of the tape by tearing thereof, the U-shaped cuts (5) are distributed and oriented along the substrate layer so that the tearing edges thereof extend in multiple directions. As a consequence, the tape will preferably be torn when peeled-off from any direction.

According to the preferred embodiment illustrated on FIG. 1, the U-shaped cuts (5) are distributed linearly along opposite longitudinal edges (7) of the substrate layer (3). More preferably, the U-shaped cuts (5) are oriented so that the closed end (5b) of each of said U-shaped cut extends either towards the corresponding longitudinal edge (7) or towards one of two directions perpendicular thereto (left and right in FIG. 1).

Compared to the X-cuts known in the Art, the multi-directional U-cuts have the principal advantage of eliminating or reducing the undesirable fragility of the tape during the customary/normal tape closing/sealing procedure while keeping a desired fragility level during the tampering attempts. Further, the Applicant has noted a net improvement in the making of the tape in that “U” Dye cutting is much easier than “X” die cutting.

As illustrated on FIG. 1, in one embodiment the tape (1) may also include a plurality of markings (9) printed onto the substrate layer (3) and overlaying the U-shaped cuts (5). Indeed, when visually reviewing the tape, the U-cuts are not necessarily prominent to the naked eye and the visible markings may advantageously further hide their presence. The markings may represent and desired shapes or words, for example a brand name of the product.

The preferred embodiment of the invention illustrated on FIG. 1 shows the brand name FRAUDSTOPPER® (9), a trade mark owned by NELMAR SECURITY PACKAGING SYSTEMS INC., repeated at 5 mm inwards (unscaled) alongside both longitudinal edges (7) of the tape. These markings (9) serve both a “commercialization/branding” purpose as well as a security purpose. This last security feature will be better detailed herein after.

Should the tape (1) be lifted off or removed from the surface on which it was initially applied to, in both “ambient” and “medium heat” temperature ranges as part of a tampering attempt the “U-CUTS” will be activated.

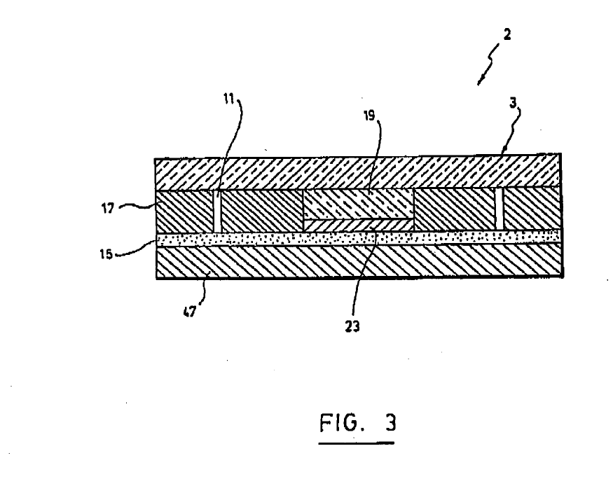

The tape (1) also includes an adhesive layer extending along the bottom surface of the substrate layer (3) for adhering the tape (1) to the package. The adhesive layer of the tape (1) may be the same as to the adhesive layer (15) of the heat sensitive tamper evident tape (2) illustrated on FIG. 3. Any kind of adhesive material well-known in the art of the making of tape and label may be used for this purpose.

Preferably, the tape (1) according to the invention may also include an ink layer sandwiched between the substrate (3) and adhesive layers. More preferably, the ink layer may define a web-like pattern (11). This last security feature will be better detailed herein after.

Preferably, the tape (1) according to the invention may further comprise a thermochromatic layer sandwiched between the substrate and adhesive layers. This last security feature will be also better detailed herein after.

As illustrated on FIG. 1, the tear-inducing tamper evident tape according to the invention may see its opposite longitudinal edges (7) of the substrate layer (3) being serrated (13).

The use of serrated edges presents a certain advantage by reducing the risk of someone attempting to tamper the tape by using a cutting tool, such as for example a razor blade, to cut along the edges of the tape to gain entry into the sealed package. This scenario is more likely when a bag is sealed with a “straight edge” tape and even more likely when the adhesive layer of the tape in question does not cover the entirety of the tape.

More preferably, the serrations found on the security tape as illustrated on the Figure are not the traditional “V” shaped type or “sharp” edges” (“juncture points”) disclosed in the prior art, but rather an innovative “U” shaped type or “softer/rounder” serrated edges. The “rounded” serrations still provide “uneven” tape edges. In addition, they eliminate any undesirable “tape fragility” during the customary/normal tape closing/sealing procedure while keeping a desired “fragility level” during tampering attempts. It has to be understood that the rounded serrated edges are used in combination with the adhesive layer which covers the entire bottom surface of the substrate layer (3), especially along the edges (7).

### Heat Sensitive Tamper Evident Tape

As aforesaid the present invention is also directed to a heat sensitive tamper evident tape for sealing a package such as cartons, envelopes, plastic bags, boxes or the like.

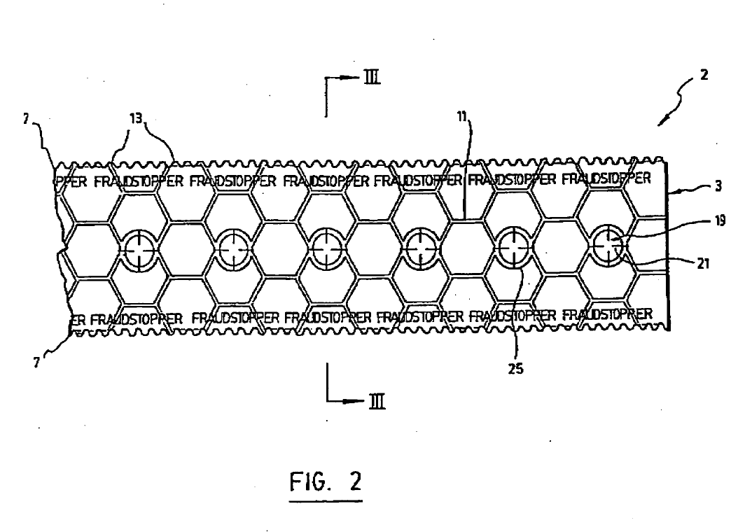

According to the embodiment illustrated on FIGS. 2 and 3, the heat sensitive tamper evident tape (2) for sealing a package includes an elongated substrate layer (3) made of a plastic material, such as the one detailed and defined herein before. The tape (2) also includes an adhesive layer (15) extending along the bottom surface of the substrate layer (3) for adhering the tape (2) to the package. Any kind of adhesive material well-known in the art of the making of tape and label may be used for this purpose.

The heat sensitive tamper evident tape (2) of the invention also has a visible ink layer (17) sandwiched between the substrate and adhesive layers (3, 15) and delimiting a plurality of heat sensitive tamper-indicating areas (19) along the substrate layer (3). The ink layer (17) also defines markings (21) within each heat sensitive tamper-indicating area (19).

The heat sensitive tamper evident tape (2) of the invention also includes a thermochromatic ink layer (23) also sandwiched between the substrate (3) and adhesive (11) layers. The thermochromatic ink layer (23) overlays the heat sensitive tamper-indicating areas (19) and is intermingled with the markings (21) therein. The thermochromatic ink layer (23) includes an irreversible thermochromatic ink invisible at room temperature and activated at an activation temperature superior to the room temperature.

Preferably, as illustrated on FIG. 2, the heat sensitive tamper evident tape (2) may have its heat sensitive tamper-indicating areas (19) linearly distributed along a longitudinal axis of the elongated substrate layer (3).

Preferably, each of the heat sensitive tamper-indicating areas (19) and the markings (21) therein represent a target (25). However, the invention is not limited to this preferred embodiment, and other kind of geometrical markings may be used within the heat area including, but not limited to, squares, circles, triangles or stars, concentric or intermingled. The markings (21) may also define a brand mark, an arrangement of lines, a logo, a word, a text, etc.

The center of the targets is coloured or not. As illustrated on FIGS. 2 and 3, the center of the targets is more preferably transparent with the exception of the markings therein (the lines within the target in the illustrated embodiment) whereas the rest of the tape is coloured by the visible ink layer (17). However, as aforesaid, a thermochromatic ink, such as the ones generally used in the Art, is applied within the area (19) of the targets.

Preferably as illustrated in FIG. 2, the targets are regularly spaced out along the median line of the tape.

The thermochromatic ink generally reacts and changes of color or becomes colored. Such inks are well known in the art. According to a preferred embodiment of the invention, the thermochromatic ink has a translucent or milky white color at room temperature and gets a “dark blue” tint once being exposed to heat. By heat, it has to be understood a higher temperature than “ambient” and/or “room temperature” defined above.

In the preferred embodiment of the invention, the thermochromatic ink is actually designed to be activated at about 160° F. (or about 70° C.) by displaying a dark blue dot. Any kind of thermochromatic ink well known and used in the art of tape may be used. The “dot” or “blue dot” is a print item chosen for its simplicity and effectiveness. The absence of blue dot on the tape means that no heat tampering has been performed. The presence of a blue dot within the tamper-indicating area, intermingled with the lines of the target, unambiguously means that exposure to extreme heat has occurred and tampering may have been attempted.

The size of the dot by the choice of a convenient placement of the ink is also carefully designed. Preferably, the ink (23) fills-in substantially the entire center circle of the area or target (19, 21) when activated, in order to provide maximum visual recognition during tampering attempts. The blue dots have also been printed in “register” as to keep the pattern as “tight” as possible. One very interesting feature of the “blue dot” graphics is that the graphics in question have been printed or sandwiched between the bottom surface of the substrate layer (3) (such as clear and transparent polymeric substrate) and the adhesive layer (15) of the tape (2). This is somewhat of a unique design and manufacturing feature.

The target pattern (25) printed directly in the tamper-indicating areas (19) of the tape (2) is a design feature that is incorporated to show evidence of someone trying to wash away the “blue dot” graphics by using solvent right after the dots were activated during a tampering attempt. The solvent may be water based or oil based solvents such as water, hot water, alcohol, acetone, ester, or the like.

Several products in the market place incorporate thermochromatic inks but none have been printed using background security patterns to show evidence of tampering via cosmetic alteration.

By “cosmetic alteration” it has to be understood that a product has been tripped and initially displays the required tamper indicating graphics Following a tampering attempt, the “triggered” tamper indicating graphics are removed or washed away and since they are usually “translucent” by nature, the tape regains its non tampered look.

The tape of the invention incorporates the “target” pattern to demonstrate if a tamper indicating event has occurred. Indeed, should the “blue dot” graphics be tripped and should someone attempt to wash away the blue dots in question, the target pattern will also be distorted or washed away, showing clear evidence of tampering and/or any cosmetic alteration attempts.

In addition to its functional side, the target pattern was chosen for its design appeal. It also provides a simple and effective background to the thermochromatic ink pattern without obstructing or hiding the blue dot graphics when “triggered”.

Preferably, the substrate layer (3) of the heat sensitive tamper evident tape (2), may also comprise a plurality of U-shaped cuts extending therethrough, such as the ones defined herein above and illustrated on FIG. 1 (5).

Preferably, the heat sensitive tamper evident tape (2) may also have its opposite longitudinal edges (7) of the substrate layer serrated (13).

Preferably, both tear-inducing or heat sensitive tamper evident tapes (1 or 2) may have their respective ink layer (13) defining a web-like pattern (11).

Preferably, the pattern (11) has a mesh of thin lines forming geometric figures selected from, but not limited to, a triangle, a square, a rectangle, a rhomboid, a pentagon and a hexagon. The meshed network may also be constituted of a plurality of rings in contact or intermingled. The meshed network may also be a spider-web like pattern.

More preferably, the geometrical figure such as the one illustrated in FIGS. 1 and 2 is a hexagon, the meshed network then defining a honeycomb background pattern. This pattern may be chosen for both its function and its cosmetic and design appeal.

Its primary function is to show evidence that the tape was cosmetically altered. Over and beyond the visual recognition of the security graphics, there will also be a clear distortion of the meshed networks themselves. Should someone attempt to cosmetically reconstruct the tape by coloring in the hidden security pattern for instance (using a similarly coloured marker or other coloring instrument) this will affect the original meshed network pattern by having the pattern in question “fill in/disappear” under the strokes of the marker.

The size of the meshes and the stroke weight of the actual mesh borders are also carefully chosen to provide optimal levels of tamper evidence and cosmetic appeal. The stroke weight is made thin enough to keep cosmetic alterations as difficult as possible while they were made thick enough to avoid filling in during the printing or manufacturing process of the tape.

The size of the meshes or honeycombs were also made large enough so that they provided sufficient solid print portions in the tape or label against which the hidden security pattern would appear during tampering attempts while keeping a tight register, and making it more difficult for anyone to try and cosmetically reconstruct the tape to a “pre-tampering” state (from a “visual” perspective).

Lastly, the honeycomb pattern is preferably chosen for its design appeal. It pulls from one of natures designs and is a symbol of overall of strength and integrity.

As for the tear-inducing tape (1) defined above, the heat sensitive tamper evident tape (2) of the invention may also comprise a sequence of markings (9) alongside the both edges (7) of the tape. For example, the preferred embodiment of the invention illustrated on FIG. 2 also shows the brand name FRAUDSTOPPER® (9) repeated alongside the both edges (7) of the tape at about 5 mm inwards (unscaled). It serves both a “commercialization/branding” purpose as well as a security purpose.

The branding aspect provides a uniqueness to the actual product (over and beyond all of the unique design/security features built-in to the tape) as well as make it a proprietary product.

The security aspect comes from the fact this external print will distort or wash-off if exposed to a solvent as the ones already mentioned above. The solvent could be used to try dissolving the adhesive backing on the tape.

This tampering technique is made very difficult by the fact that the tape preferably comes with 100% adhesive backing/coverage which reduces the probability of the solvents/alcohols getting underneath the tape to ultimately dissolve the adhesive in question.

The probability of a solvent to reach the outside of the tape is significant in this scenario, in which case, the external tape would show evidence of being exposed to such materials.

### Other Security Features

Although the following is not illustrated by the enclosed figures, the tapes according to the present invention may also contains hidden security patterns which have been designed to work “hand-in-hand” with the meshed network security background pattern disclosed herein above. This may include the use of a layer of release material, patterned to form the warning message, being disposed between the adhesive layer of the tape and the ink layer forming the honeycomb security pattern. Upon removing the tape from a package, the portion of the ink layer in contact with the release material remains on the package, forming the warning message, and the absence of ink on the tape substrate will also form the warning message. In addition, should someone attempt to “freeze” or “peel” open (at ambient temperatures) the tape, the hidden security pattern will appear and distort or break the honeycomb security pattern. Hidden security patterns are selected from, but limited to, specific words to which the meaning indicates that a temper attempts has occurred. These words or symbols may be “VOID”, “X”, “OPENED”, “TAMPERED”, or the like. The size and positioning of the hidden security patterns have been developed to maximize the overall effectiveness of the tape during tampering attempts.

As an additional level of security not illustrated in the enclosed Figures, the tape according to the invention may also be printed with a clear/matte exterior finish. Indeed, the plastic material used to manufacture the substrate layer is generally glossy and shinny by nature. The addition of a “clear/matte” ink on the outside of the tape alters the finish of the tape. Should a tampering “event” occur via the aid of a solvent, the exterior matte finish will be dissolved or washed-away, and the “glossy/shinny” finish of the substrate will peer through and provide another evidence of tampering.

### Tear-Inducing Tamper Evident Soft Package

As aforesaid, the present invention is further directed to a tear-inducing tamper evident soft package herein after merely named “package”.

By “soft package”, it is understood a package made of a soft material such as a bag or an envelop made of a plastic material or paper. The plastic may be transparent or opaque. Preferably, the soft package is made of a plastic material such as the ones generally used in the art of plastic bags.

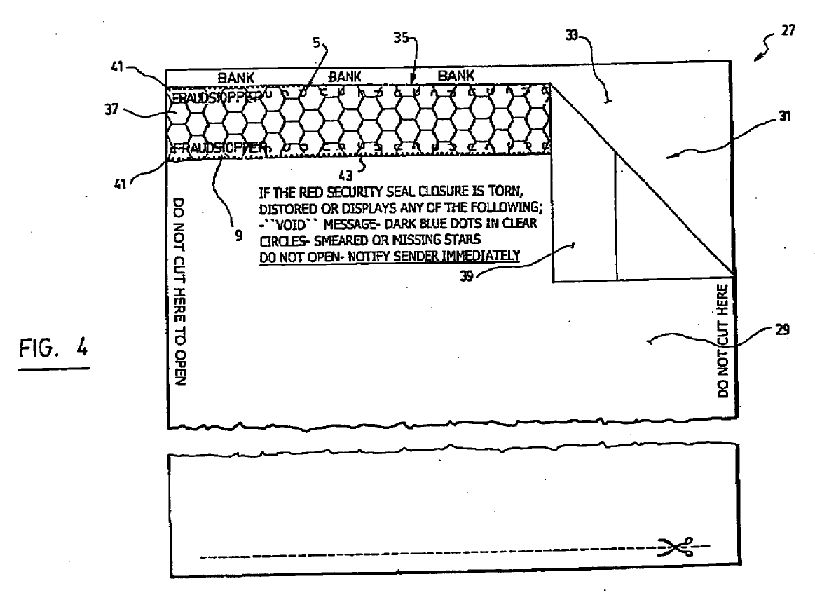

According to a preferred embodiment of the present invention, as the one illustrated on FIG. 4, the package (27), has a first wall (29) and a second wall (31) made of a soft material and joined together to form an enclosure having an opening (33).

The package also has an elongated sealing region (35) extending longitudinally along the opening and having an outside and inside surface. The sealing region includes an elongated substrate layer (37) having a bottom surface facing inwardly of the opening. The substrate layer has a plurality of U-shaped cuts (5) extending therethrough.

The U-shaped cut have an open end and a closed end, the closed end defining a tearing edge. The U-shaped cuts being distributed and oriented along the substrate layer so that the tearing edges thereof extend in multiple directions. The sealing region (35) also includes an adhesive layer (39) extending along the bottom surface of the substrate layer (37) and disposed to contact both the first (29) and second (31) walls for sealing the package (27).

Preferably, the elongated substrate layer (37) of the sealing region (35) may be integral to the first wall (29).

Alternatively, the substrate layer (37) and the adhesive layer (39) may define a tape, their first and second longitudinal portions thereof adhering to the first wall and second wall, respectively, upon sealing the package. The tape is then similar to the tearing-inducing tape of the invention defined herein before.

Then, as for the tear-inducing tamper evident tape (1) illustrated on FIG. 1, the U-shaped cuts (5) of the sealing region (35) of the tear-inducing tamper evident soft package (27) may be preferably distributed linearly along opposite longitudinal edges (41) of the substrate layer (37). More preferably, the U-shaped cuts (5) may be oriented so that the closed end of each of the U-shaped cut extends either towards the corresponding longitudinal edge or towards one of two directions perpendicular thereto.

Also, as for the tear-inducing tamper evident tape (1) illustrated on FIG. 1, the tear-inducing tamper evident soft package (27) illustrated on FIG. 4 may further include a plurality of markings (9) printed onto the substrate layer (37) overlaying the U-shaped cuts (5); an ink layer sandwiched between the substrate and adhesive layers, which more preferably may define a web-like pattern and even more preferably a honeycomb pattern (11); a thermochromatic layer sandwiched between the substrate (37) and adhesive layers; and/or serrated opposite longitudinal edges (43) of the substrate layer.

### Heat Sensitive Tamper Evident Soft Package

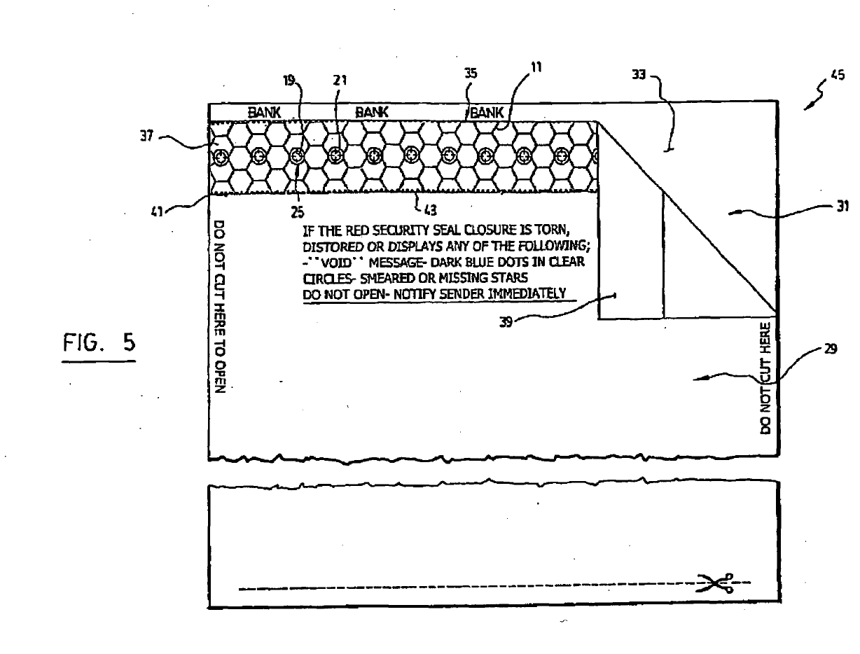

As aforesaid, the present invention is also directed to a heat sensitive tamper evident soft package. According to the preferred embodiment illustrated on FIG. 5, the package (45) also comprises a first (29) and a second (31) wall made of a soft material and joined together to form an enclosure having an opening (33).

The heat sensitive tamper evident soft package (45) also comprises an elongated sealing region (35) extending longitudinally along the opening (33) and having an outside and inside surface. The sealing region (35) includes an elongated substrate layer (37) having a bottom surface facing inwardly of the opening and an adhesive layer (39) extending along the bottom surface of the substrate layer and disposed to contact both the first and second walls for sealing the package (45).

The sealing region (35) also includes an ink layer sandwiched between the substrate and adhesive layers and delimiting a plurality of heat sensitive tamper-indicating areas (19) along the substrate layer (37). The ink layer defines markings (21) within each heat sensitive tamper-indicating area (19). The sealing region (35) also includes a thermochromatic layer sandwiched between the substrate and adhesive layers, overlaying the heat sensitive tamper-indicating areas (19) and being intermingled with the markings (21) therein. The thermochromatic layer comprises an irreversible thermochromatic ink invisible at room temperature and activated at an activation temperature superior to the room temperature.

Soft material, thermochromatic ink, or room temperature mentioned above is as previously defined.

Preferably, the elongated substrate layer (37) of the sealing region (35) may be integral to the first wall (29).

Alternatively, the substrate and adhesive layers (37) may define a heat sensitive tamper evident tape having its first and second longitudinal portions adhering to the first wall (29) and second (31) wall, respectively, upon sealing the package (45).

Preferably, the heat sensitive tamper-indicating areas (19) may be linearly and equidistantly distribute along the elongated substrate layer (37). As illustrated on FIG. 4, each of the heat sensitive tamper-indicating areas (19) and the markings (21) therein may represent a target (25).

Optionally, the substrate layer (37) of the heat sensitive tamper evident soft package (45) may include a plurality of U-shaped cuts as the ones defined previously (No. 5, FIG. 1).

The ink layer of the heat sensitive tamper evident soft package may preferably define a web-like pattern (11), such as a honeycomb pattern.

Preferably, opposite longitudinal edges of the substrate layer may also be serrated (43).

Of course, as illustrated on FIG. 3, the tapes and sealing portions of the packages disclosed and claimed herein may further comprise an inferior layer (47), also named a liner backer, made of a material, such as scored paper, which slightly adhere to the adhesive layer. The backer should be previously peeled off from the adhesive layer before to use the tape or to close the opening of the soft package.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. A tear-inducing tamper evident tape for sealing a package, comprising:
an elongated substrate layer made of a plastic material and having a top and a bottom surface, said substrate layer having a plurality of U-shaped cuts extending therethrough, each U-shaped cut having an open end and a closed end, the closed end defining a tearing edge, said U-shaped cuts being distributed and oriented along the substrate layer so that the tearing edges thereof extend in multiple directions; and
an adhesive layer extending along said bottom surface of the substrate layer for adhering the tape to the package.

2. The tear-inducing tamper evident tape according to claim 1, wherein said U-shaped cuts are distributed linearly along opposite longitudinal edges of the substrate layer.

3. The tear-inducing tamper evident tape according to claim 2, wherein said U-shaped cuts are oriented so that the closed end of each of said U-shaped cut extends either towards the corresponding longitudinal edge or towards one of two directions perpendicular thereto.

4. The tear-inducing tamper evident tape according to claim 1, further comprising a plurality of markings printed onto said substrate layer overlaying said U-shaped cuts.

5. The tear-inducing tamper evident tape according to claim 1, further comprising a visible ink layer sandwiched between the substrate and adhesive layers said visible ink layer defining a web-like pattern.

6. A heat sensitive tamper evident tape for sealing a package, comprising:
an elongated substrate layer made of a plastic material having a top and a bottom surface;
an adhesive layer extending along said bottom surface of the substrate layer for adhering the tape to the package;
a visible ink layer sandwiched between the substrate and adhesive layers and delimiting a plurality of heat sensitive tamper-indicating areas along the substrate layer, said visible ink layer defining markings within each heat sensitive tamper-indicating area; and
a thermochromatic ink layer sandwiched between the substrate and adhesive layers, said thermochromatic ink layer overlaying the heat sensitive tamper-indicating areas and being intermingled with the markings therein, the thermochromatic layer comprising an irreversible thermochromatic ink invisible at room temperature and activated at an activation temperature superior to the room temperature.

7. The heat sensitive tamper evident tape according to claim 6, wherein said heat sensitive tamper-indicating areas are linearly distributed along a longitudinal axis of said elongated substrate layer.

8. The heat sensitive tamper evident tape according to claim 6, wherein each of said heat sensitive tamper-indicating areas and the markings therein represent a target.

9. The heat sensitive tamper evident tape according to claim 6, wherein said substrate layer comprises a plurality of U-shaped cuts extending therethrough, each U-shaped cut having an open end and a closed end, the closed end defining a tearing edge, said U-shaped cuts being distributed and oriented along the substrate layer so that the tearing edges thereof extend in multiple directions.

10. The heat sensitive tamper evident tape according to claim 6, wherein said visible ink layer further defines a web-like pattern.

11. A tear-inducing tamper evident soft package, comprising:
a first and a second wall made of a soft material and joined together to form an enclosure having an opening, and
an elongated sealing region extending longitudinally along the opening and having an outside and inside surface, said sealing region comprising:
an elongated substrate layer having a bottom surface facing inwardly of said opening, said substrate layer having a plurality of U-shaped cuts extending therethrough, each U-shaped cut having an open end and a closed end, the closed end defining a tearing edge, said U-shaped cuts being distributed and oriented along the substrate layer so that the tearing edges thereof extend in multiple directions; and
an adhesive layer extending along said bottom surface of the substrate layer and disposed to contact both the first and second walls for sealing the package.

12. The tear-inducing tamper evident soft package according to claim 11, wherein said elongated substrate layer is integral to said first wall.

13. The tear-inducing tamper evident soft package according to claim 11, wherein said substrate layer and adhesive layer define a tape, first and second longitudinal portions thereof adhering to the first wall and second wall, respectively, upon sealing said package.

14. The tear-inducing tamper evident soft package according to claim 11, wherein said U-shaped cuts are distributed linearly along opposite longitudinal edges of the substrate layer.

15. The tear-inducing tamper evident soft package according to claim 11, wherein said U-shaped cuts are oriented so that the closed end of each of said U-shaped cut extends either towards the corresponding longitudinal edge or towards one of two directions perpendicular thereto.

16. The tear-inducing tamper evident soft package according to claim 11, further comprising a plurality of markings printed onto said substrate layer overlaying said U-shaped cuts.

17. A heat sensitive tamper evident soft package, comprising:
a first and a second wall made of a soft material and joined together to form an enclosure having an opening, and
an elongated sealing region extending longitudinally along the opening and having an outside and inside surface, said sealing region comprising:
an elongated substrate layer having a bottom surface facing inwardly of said opening,
an adhesive layer extending along said bottom surface of the substrate layer and disposed to contact both the first and second walls for sealing the package;
a visible ink layer sandwiched between the substrate and adhesive layers and delimiting a plurality of heat sensitive tamper-indicating areas along the substrate layer, said visible ink layer defining markings within each heat sensitive tamper-indicating area; and
a thermochromatic ink layer sandwiched between the substrate and adhesive layers, said thermochromatic ink layer overlaying the heat sensitive tamper-indicating areas and being intermingled with the markings therein, the thermochromatic layer comprising an irreversible thermochromatic ink invisible at room temperature and activated at an activation temperature superior to the room temperature.

18. The heat sensitive tamper evident soft package according to claim 17, wherein said elongated substrate layer is integral to said first wall.

19. The heat sensitive tamper evident soft package according to claim 17, wherein said substrate layer and adhesive layer define a tape, first and second longitudinal portions thereof adhering to the first wall and second wall, respectively, upon sealing said package.

20. The heat sensitive tamper evident soft package according to claim 17, wherein said heat sensitive tamper-indicating areas are linearly distributed along a longitudinal axis of said elongated substrate layer.

21. The heat sensitive tamper evident soft package according to claim 17, wherein each of said heat sensitive tamper-indicating areas and the markings therein represent a target.
